(19) United States
(12) Patent Application Publication
(10) Pub. No.: US 2009/0318017 A1
(43) Pub. Date: Dec. 24, 2009

(54) Small Foot Print Rugged Low Cost RF Connector with Improved Performance

(76) Inventors: Lu Fan, Plano, TX (US); Thuy Viet Nguyen Vo, Wylie, TX (US); Adolfo Echeverria Del Rio, Wylie, TX (US); Henry Patrick Largey, Wylie, TX (US)

Correspondence Address: TEXAS INSTRUMENTS INCORPORATED, P O BOX 655474, M/S 3999, DALLAS, TX, 75265, US

(21) Appl. No.: 12/143,127

(22) Filed: Jun. 20, 2008

(51) Int. Cl. H01R 9/05

(52) U.S. Cl. 439/578

(57) ABSTRACT

An RF launch architecture that includes a circuit board including a conducting trace on a first side with a via proximate to the conducting trace and extending from the first side through the circuit board to a second side. Also included is an RF coaxial cable that has 1) a ferrule, coupled with a metallic shield of the cable, coupled with the second side and in electrical communication with the second side, 2) an insulator extending through the via to exit from the first side, wherein the ferrule surrounds a portion of a periphery of the insulator; and 3) a center core located within the insulator and extending through the via to exit from the first side, the center core extending above the insulator.

### BACKGROUND

1. Field

The present invention relates generally to radio frequency (RF) circuitry and, more particularly, to an RF launch architecture.

2. Description of Related Art

There are a number of instances where it is beneficial to connect a coaxial cable to a circuit board and, thus, there have been many approaches to providing an RF interconnect or RF launch architecture on a circuit board. One end of the coaxial cable is connected to the RF launch architecture and the other end of the coaxial cable is made available for external connections.

In the past, a connector of some type has been soldered to the circuit board so that a signal trace is coupled to a part of the connector which interfaces with the center core of the coaxial cable and the ground traces on the board are coupled to a part of the connector which interfaces with the metallic braid of the cable. The cable then has an appropriately matching connector on one of its end so that it can fit within the connector on the circuit board.

Three shortcomings of this approach is that it requires a large area of the circuit board to provide the RF launch architecture, secondly, signal attenuation and loss may be unacceptable especially at higher frequencies, and thirdly, this type of connector may mechanically fail. A fourth shortcoming is the added cost of the material and labor of providing the circuit board RF connector.

There have been some attempts that try to minimize the circuit board area by using smaller size connectors. For example, SMP connectors have become the standard sized board-mounted connectors in most instances over the much larger sized SMA connectors. However, SMP connectors still require a significant amount of circuit board area (about 30 mm²) and their performance is sometimes less than ideal.

Accordingly, there remains an unfilled need in this technology for an RF launch architecture that minimizes circuit board real-estate, provides high performance, is rugged, and is easy and economical to implement.

### BRIEF SUMMARY

Embodiments of the present invention relate to an RF launch architecture that includes a circuit board including a conducting trace on a first side with a via proximate to the conducting trace and extending from the first side through the circuit board to a second side. Also included is an RF coaxial cable that has 1) a ferrule, coupled with a metallic shield of the cable, coupled with the second side and in electrical communication with the second side, 2) an insulator extending through the via to exit from the first side, wherein the ferrule surrounds a portion of a periphery of the insulator; and 3) a center core located within the insulator and extending through the via to exit from the first side, the center core extending above the insulator.

This allows the metallic shield of the coaxial cable to be coupled to ground traces on the circuit board and also allows the center core to be coupled to the conducting trace in a manner that provides robust high-frequency performance yet minimizes the circuit board real-estate dedicated to the RF launch architecture.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF DRAWINGS

Various aspects of embodiments of the invention are illustrated by way of example, and not by way of limitation, in the accompanying drawings, wherein:

FIG. 1 depicts a side cutaway view of an RF launch architecture in accordance with the principles of the present invention;

FIG. 2 depicts a top view of the RF launch architecture of FIG. 1;

FIG. 3 depicts a view similar that of FIG. 1 but shows the cable portion without being attached to the circuit board; and

FIG. 4 depicts an exemplary cable utilized within the RF launch architecture in accordance with the principles of the present invention.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

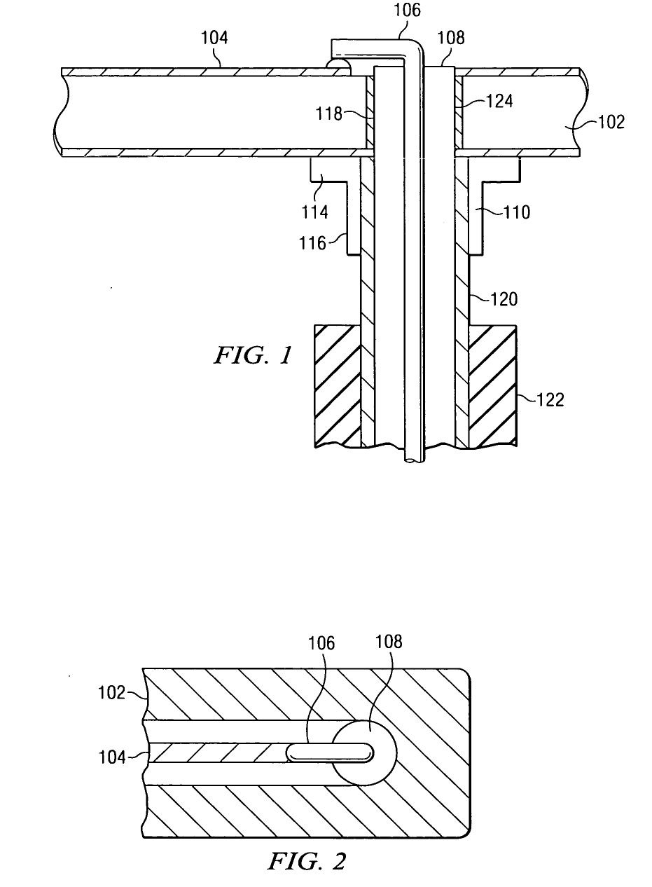

FIG. 1 depicts a side cutaway view of an RF launch architecture in accordance with the principles of the present invention. The end of an RF coaxial cable is shown in FIG. 1 that is connected with a circuit board 102. As is known, a coaxial cable includes a center core 106, an insulator 108 surrounding the center core 106 and a metallic shield 120 (often referred to as “ground”). This structure is then surrounded by a protective jacket 122. The protective jacket is frequently some type of plastic or can also have a metallic outer shell for even more ruggedness.

The cable of FIG. 1 includes an additional item—the conductive ferrule 110. This ferrule fits around the insulator 108 and includes a flange 114 and cylindrical body 116. This ferrule 110 is connected at the end of the coaxial cable so that it is in electrical communication with the metallic shield 120 that surrounds the insulator 108. Thus, in operation, this metallic shield 120 would extend up so as to contact the ferrule 110. This contact can be accomplished by soldering portions of the metallic shield 120 to the cylindrical body 116 or by crimping, or otherwise coupling, some type of sleeve around the end that forces and ensures contact between the metallic shield 120 and the ferrule 110. As shown in the figure, the shield 120 extends into the inside of the ferrule 110 along almost its entire length. However, the shield 120 does not have to extend this far into the ferrule 110 to achieve the desired electrical connectivity. Additionally, the shield 120 could alternatively be located on the outside of the ferrule 110 and still achieve the desired electrical connectivity with the ferrule 110 by a variety of coupling techniques. One of ordinary skill will recognize that a number of different methods may be used to attach the ferrule to the end of a coaxial cable so that the ferrule is in electrical communication with the metallic shield.

The cable is inserted though a via 118 of the circuit board 102. In one embodiment, the via is sized so as to closely match the outer diameter of the insulator 108 of the coaxial cable. With the flange 114 of the ferrule 110 seated flatly across the bottom side of the circuit board 102, the insulator 108 extends roughly to both the height of the traces 104 and the circuit board 102. The insulator may extend slightly higher than the trace 104 to help improve insulation but extension of more than 0.01 inches provides little benefit. However, the specific size of the extension depends primarily on the diameter of the cable and shorter or larger extension sizes are contemplated for smaller and larger sized cables.

As shown, the center core 106 extends farther than the insulator 108 so that it can be bent over at approximately 90 degrees to be soldered to the trace 104 that is near the via 118. The ferrule 110 is also soldered, bonded, or otherwise coupled, into place so that it provides electrical communication from the metallic shield to any traces on the bottom side of board 102. The via 118 may lined with a conductive material 124 that, itself may be plated with, for example, gold, so that the ferrule 110 on the bottom side of the board 102 may be in electrical communication with the via 118 so that the coaxial nature of the cable continues through to the top of the via 118. Thus the via 118 acts as the shielding that is typically part of a coaxial cable structure. In some instances the via 118 may be connected to traces on the top of the board as well so that the ferrule 110 is in electrical communication with the top side of the board 102.

FIG. 2 depicts a top view of the RF launch architecture of FIG. 1. This top view shows the minimal area on the circuit board which is occupied by the RF launch architecture that provides the transition from the coaxial cable to the trace 104. The trace 104 may preferably be a microstrip line as is known in the industry.

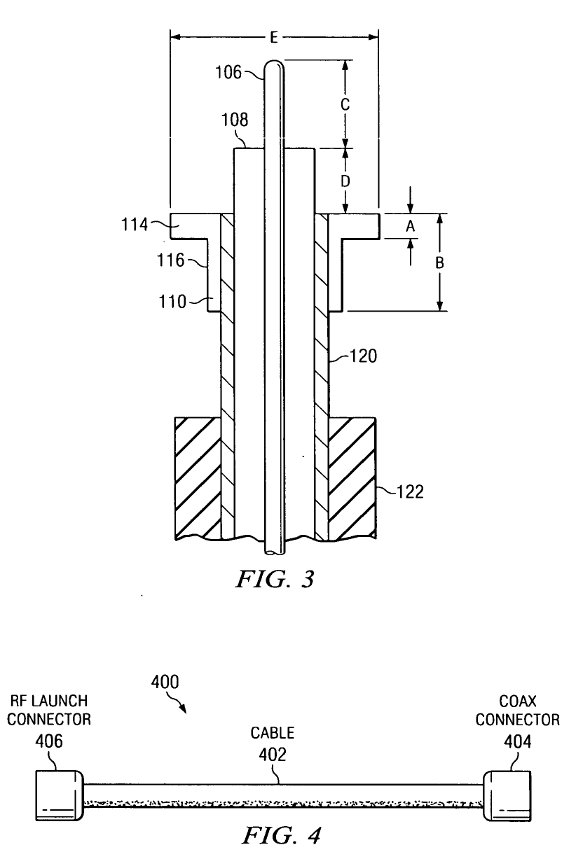

FIG. 3 depicts a view similar that of FIG. 1 but shows the cable portion without being attached to the circuit board. There are a number of dimensions depicted within FIG. 3 and their actual values depend on the application in which various instances of the present RF launch architecture is employed. However, one specific example is described below with explicit values for these dimensions. This specific example is not intended to limit the present invention to only these values but is provide merely as an illustrative configuration with the proportions as indicated. As one of ordinary skill will recognize, manufacturing tolerances of high frequency components as well as their material can play a role in the overall performance of a system utilizing those components. Thus, the example dimensions provided below, and the materials mentioned herein, are intended to be approximate within the manufacturing limits and material selection typical of components operating at the frequencies contemplated within embodiments of the present invention. As for examples of such ranges, many uses exist for RF launch architectures in the GHz range and even up to around 100 GHz.

The ferrule 110 may have a length B along its major axis of about 0.200 inches which provides sufficient area to ensure a quality coupling to the metallic shield of the coaxial cable. The flange 114 may have an outer diameter E of about 0.120 inches and a thickness A of about 0.02 inches. This provides a mechanically rugged structure that can be securely attached to the underside of the circuit board 102. The length D of the insulator portion extending above the ferrule 110 is about 0.193 inches and the length C of the center core 106 portion that extends above the insulator is about 0.10 inches. These sizes allow the cable end to extend through a standard circuit board about 0.187 inches thick and for the center core 106 to reach a trace less than 0.10 inches away. This arrangement also results in a structure that provides improved electrical performance over past RF launch architectures especially at frequencies in the GHz range and occupies only about 6 mm² of real-estate on the top of the circuit board 102.

FIG. 4 depicts an exemplary cable assembly 400 utilized within the RF launch architecture in accordance with the principles of the present invention. The previous figures have focused on the cable end 406 that is to be connected to the circuit board 102. However, that cable assembly 400 also extends in the other direction for a customizable length of cable 402 that terminates with a standard coaxial connector 404. This connector 404 can be selected from any of the industry standard interfaces that exist and that may be developed in the future. In this way, an RF signal may be communicated between an external device which couples to the connector 404 and circuitry on the circuit board 102.

In one embodiment described above, the metallic shield 120 ended either within the ferrule 110 or outside of the ferrule 110. However, in an alternative embodiment in which the via 118 is not lined with a conductive material, the metallic shield 120 may extend up through the ferrule 110 and into the via 118. While the metallic shield 120 may only extend partially into the via 118 it is beneficial for it to end substantially flush with the top side of the circuit board 102. In this instance, of course, the via 118 is large enough to accommodate the outside diameter of the metallic shield 120.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. Also, the term “exemplary” is meant to indicate that some information is being provided as an example only as is not intended to mean that information is somehow special or preferred. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An assembly comprising:
a circuit board including a conducting trace on a first side;
a via proximate to the conducting trace and extending from the first side through the circuit board to a second side; and
a radio frequency coaxial cable comprising:
a ferrule, coupled with a metallic shield of the cable, coupled with the second side and in electrical communication with the second side;
an insulator extending through the via to exit from the first side, wherein the ferrule surrounds a portion of a periphery of the insulator;
a center core located within the insulator and extending through the via to exit from the first side, the center core extending above the insulator.

2. The assembly of claim 1, wherein the ferrule is in electrical communication with the first side.

3. The assembly of claim 1, wherein the center core is in electrical communication with the conducting trace.

4. The assembly of claim 1, wherein the center core is bent at an angle of approximately 90 degrees so that a first end of the center core is proximate to the conducting trace.

5. The assembly of claim 1, wherein a length of the center core extending above the insulator is about 0.1 inches.

6. The assembly of claim 1, wherein the conducting trace is a micro strip line.

7. The assembly of claim 1, wherein the center core is soldered to the conducting trace.

8. The assembly of claim 1, wherein the ferrule is soldered to the second side.

9. The assembly of claim 1, wherein the metallic shield extends through the ferrule and at least partially within the via.

10. The assembly of claim 1, wherein the via is lined with a conducting material.

11. The assembly of claim 1, wherein the metallic shield extends within the ferrule.

12. The assembly of claim 1, wherein a first end the insulator extending through the via is substantially flush with a surface of the conducting trace.

13. The assembly of claim 1, wherein the radio frequency coaxial cable further comprises:
an end opposite the circuit board, wherein the end is coupled with an industry standard coaxial connector.

14. A coaxial cable with a first cable and a second cable end, the second cable end configured to connect to an RF launch area of a circuit board, the cable comprising:
the first cable end configured to couple with an industry standard coaxial connector; and
the second cable end includes:
a cylindrical ferrule in electrical communication with a metallic shield of the cable, the ferrule having a major axis aligned with a major axis of the cable and a first end and second end, wherein the first end is closer than the second end to the first cable end and the second end includes a flange substantially perpendicular to the major axis of the ferrule;
an insulator extending a first distance through the ferrule, away from the first cable end;
a center core within the insulator extending a second distance through the ferrule, away from the first cable end and wherein the second distance is greater than the first distance.

15. The coaxial cable of claim 14, wherein the second distance is about 0.1 inches more than the first distance.

16. The coaxial cable of claim 14, wherein the first distance is about 0.2 inches.

17. The coaxial cable of claim 14, wherein an outside diameter of the flange is about 0.12 inches.

18. A method of connecting a coaxial cable to an RF launch area of a circuit board comprising the steps of:
attaching a ferrule to a second side of the circuit board, the ferrule in electrical communication with a metallic shield of the coaxial cable;
positioning a portion of an insulator of the coaxial cable through a via of the circuit board, the via extending from the second side to a first side of the circuit board;
positioning a portion of a center core of the coaxial cable through the via such that a first end of the center core extends above the insulator on the first side of the circuit board;
and electrically connecting the first end of the center core to a trace on the first side of the circuit board.

19. The method of claim 18, further comprising the step of:
attaching an industry standard coaxial connector to an end of the coaxial cable opposite the circuit board.

20. The method of claim 18, wherein the via is plated with a conductor.
